(19) United States
(12) Patent Application Publication
(10) Pub. No.: US 2026/0178852 A1
(43) Pub. Date: Jun. 25, 2026

(54) MOBILE ELECTRONIC CODE DEVICE

(71) Applicant: Adele Williams, Escondido, CA (US)

(72) Inventor: Adele Williams, Escondido, CA (US)

(21) Appl. No.: 18/987,961

(22) Filed: Dec. 19, 2024

(51) Int. Cl. G06F 40/58

(52) U.S. Cl. CPC G06F 40/58

(57) ABSTRACT

A mobile electronic code device includes a personal electronic device carried by a recipient user. The personal electronic device has a transceiver which receives a communication signal from an extrinsic communication network. An electronic memory is integrated into the personal electronic device which stores a language translation program. The language translation program translates a message in the communication signal into a coded audio signal to audibly communicate the message to the recipient user in a code that only the recipient user can understand thereby enhancing privacy for the recipient user. A speaker is integrated into the personal electronic device to audibly emit the coded audio signal to the recipient user through the plurality of sound holes.

### STATEMENT REGARDING FEDERALLY SPONSORED RESEARCH OR DEVELOPMENT

Not Applicable

### CROSS-REFERENCE TO RELATED APPLICATIONS

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to code devices and more particularly pertains to a new code device for translating a phone call into a coded audio that only a recipient user can understand. The device includes a personal electronic device that stores a language translation program and speaker integrated into the personal electronic device. The language translation program translates an incoming message into coded audio, which his emitted by the speaker, that only the recipient user can understand thereby enhancing privacy for the recipient user.

### (2) Description of Related Art Including Information Disclosed Under 37 CFR 1.97 and 1.98

The prior art relates to code devices including: a wireless mobile phone device that facilitates entry of transmission of Morse code messages; a code generator system that generates a Morse code message from a received message and decodes a received Morse code message; an in-game API wrapper transcribing visual data and audio data of a video game into Morse code; a Morse code communication system that provides haptic feedback for a Morse code message. In no instance does the prior art disclose a mobile electronic code device that translates an incoming message into a coded audio signal that only a recipient of the incoming message can understand.

### BRIEF SUMMARY OF THE INVENTION

An embodiment of the disclosure meets the needs presented above by generally comprising a personal electronic device carried by a recipient user. The personal electronic device has a transceiver which receives a communication signal from an extrinsic communication network. An electronic memory is integrated into the personal electronic device which stores a language translation program. The language translation program translates a message in the communication signal into a coded audio signal to audibly communicate the message to the recipient user in a code that only the recipient user can understand thereby enhancing privacy for the recipient user. A speaker is integrated into the personal electronic device to audibly emit the coded audio signal to the recipient user through the plurality of sound holes.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a mobile electronic code device according to an embodiment of the disclosure.

FIG. 2 is a back perspective view of an embodiment of the disclosure.

FIG. 3 is a schematic view of an embodiment of the disclosure.

### DETAILED DESCRIPTION OF THE INVENTION

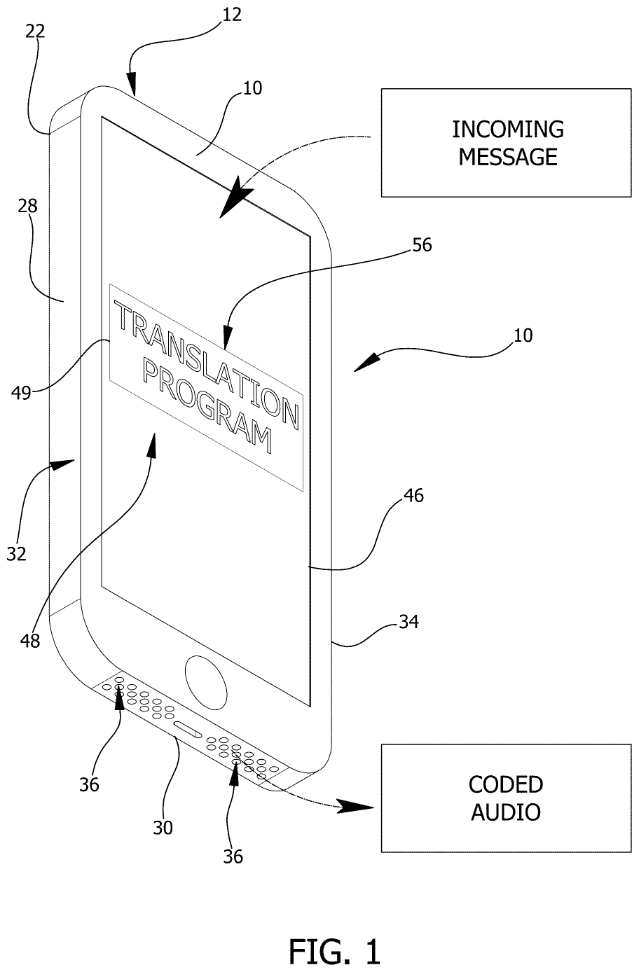

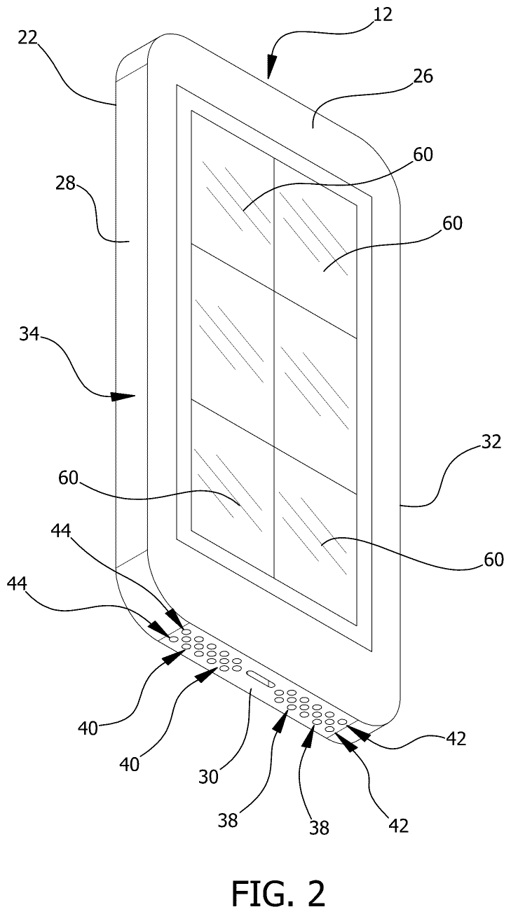

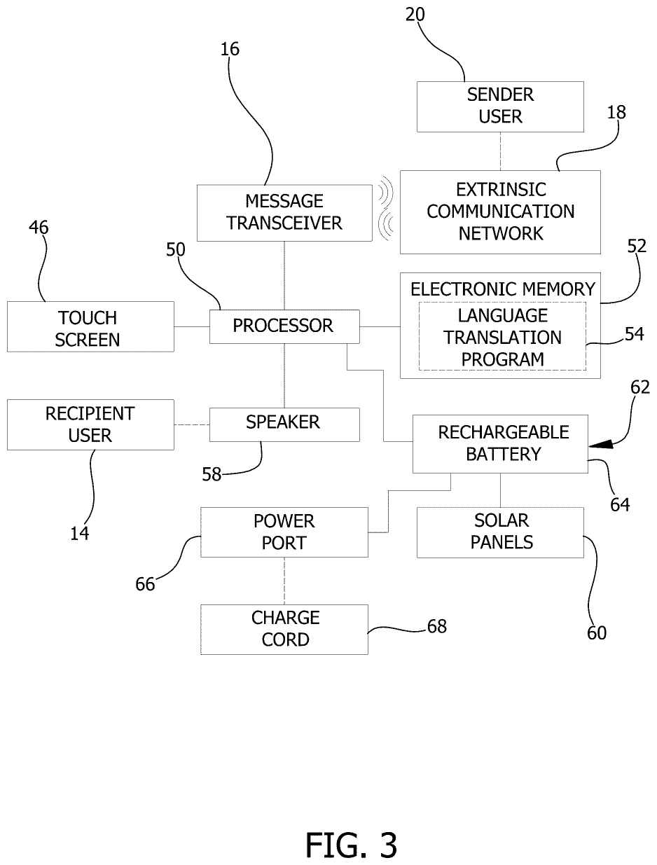

With reference now to the drawings, and in particular to FIGS. 1 through 3 thereof, a new code device embodying the principles and concepts of an embodiment of the disclosure and generally designated by the reference numeral 10 will be described.

As best illustrated in FIGS. 1 through 3, the mobile electronic code device 10 generally comprises a personal electronic device 12 which is carried by a recipient user 14. The personal electronic device 12 has a transceiver 16 that is in wireless communication with an extrinsic communication network 18. Furthermore, the transceiver 16 receives a communication signal from the extrinsic communication network 18 such that the transceiver 16 can receive an incoming message from a sender user 20 that is intended for the recipient user 14. The incoming message may be a phone call or a text message or any other means of communication commonly associate with electronic communication. The personal electronic device 12 may comprise a smart phone, or other similar type of electronic device that has wireless communication capabilities, and the extrinsic communication network 18 may comprise a cellular phone network, the internet or other type of global communication network. Additionally, the transceiver 16 may comprise a radio frequency transceiver or the like the transceiver 16 may employ WPAN communication protocols.

The personal electronic device 12 includes a housing 22 that has a front wall 24 and a back wall 26 and an outer wall 28 extending between the front wall 24 and the back wall 26. The outer wall 28 has a bottom side 30 and a first lateral side 32 and a second lateral side 34. Furthermore, the outer wall 28 has a plurality of sound holes 36 extending through the bottom side 30 such that the plurality of sound holes 36 can pass audible sounds through the bottom side 30. Additionally, the plurality of sound holes 36 includes a plurality of first sound holes 38 and a plurality of second sound holes 40.

The plurality of first sound holes 38 is positioned between a center of the bottom side 30 and the first lateral side 32. The plurality of first sound holes 38 is arranged in a plurality of first rows 42 which are evenly spaced apart from each other and are distributed between the front wall 24 and the back wall 26. Additionally, the plurality of first rows 42 is staggered with respect to each other thereby offsetting each first sound hole 38 of the plurality of first sound holes 38 in a respective first row 42 of the plurality of first rows 42 with respect to a respective first sound hole 38 of the plurality of first sound holes 38 in an adjacent first row 42 of the plurality of first rows 42. The plurality of second sound holes 40 is positioned between the center of the bottom side 30 and the second lateral side 34. The plurality of second sound holes 40 is arranged in a plurality of second rows 44 which are evenly spaced apart from each other and are distributed between the front wall 24 and the back wall 26. Additionally, the plurality of second rows 44 is staggered with respect to each other thereby offsetting each second sound hole 40 of the plurality of second sound holes 40 in a respective second row 44 of the plurality of second rows 44 with respect to a respective second sound hole 40 of the plurality of second sound holes 40 in an adjacent second row 44 of the plurality of second rows 44.

A touch screen 46 is integrated into the front wall 24 of the housing 22 and the touch screen 46 is sensitive to touch such that the touch screen 46 can respond to being touched by the recipient user 14. The touch screen 46 touch displays indicia 48 comprising a graphical user interface 49 which can respond to operational commands from the recipient user 14 when the recipient user 14 touches the touch screen 46. The touch screen 46 may comprise a liquid crystal touch screen or other type of electronic touch screen that can display color imagery. A processor 50 is integrated into the personal electronic device 12; the processor 50 is in electrical communication with the transceiver 16 and the processor 50 is in electrical communication with the touch screen 46.

An electronic memory 52 is integrated into the personal electronic device 12 and the electronic memory 52 is in electrical communication with the processor 50. The electronic memory 52 stores a database comprising a language translation program 54 and the language translation program 54 translates a message in the communication signal into a coded audio signal. Furthermore, the language translation program 54 communicates the message to the recipient user 14 in a code that only the recipient user 14 can understand thereby enhancing privacy for the recipient user 14. The language translation program 54 is turned on when a translate icon 56 of the graphical user interface 49 is selected such that the touch screen 46 enables the language translation program 54 to be turned on and off based upon a decision of the recipient user 14 to select the translate icon 56. The code associated with the coded audio may be Morse code, Julius Ceasar's code or other type of pre-existing code. Furthermore, the code associated with the coded audio may be a code that was specifically designed and chosen by the recipient user 14 or a native language of the recipient user 14.

A speaker 58 is integrated into the personal electronic device 12 and the speaker 58 is aligned with the plurality of sound holes 36 to emit audible sounds outwardly through the plurality of sound holes 36. The speaker 58 is in electrical communication with the processor 50 such that the speaker 58 receives the coded audio signal from the language translation program 54. Furthermore, the speaker 58 audibly emits the coded audio signal to the recipient user 14 through the plurality of sound holes 36. The speaker 58 may comprise an electronic speaker of any conventional design that is commonly associated with smart phones, for example.

A plurality of solar cells 60 is provided and each solar cell 60 of the plurality of solar cells 60 is coupled to the personal electronic device 12 such that each solar cell 60 of the plurality of solar cells 60 can be exposed to sunlight for charging the personal electronic device 12. Each solar cell 60 of the plurality of solar cells 60 is positioned on the back wall 26 of the housing 22 and the plurality of solar cells 60 is in electrical communication with the processor 50. A power supply 62 is integrated into the housing 22 and the power supply 62 is in electrical communication with the processor 50 such that the plurality of solar cells 60 charges the power supply 62. The power supply 62 includes a rechargeable battery 64 that is positioned within the housing 22 and the rechargeable battery 64 is in electrical communication with the processor 50.

The power supply 62 includes a charge port 66 that is recessed into the bottom side 30 of the outer wall 28 of the housing 22 and the charge port 66 can be electrically mated to a charge cord 68. The charge port 66 is in electrical communication with the rechargeable battery 64 for charging the rechargeable battery 64. Furthermore, the charge port 66 is located between the plurality of first sound holes 38 and the plurality of second sound holes 40. The charge port 66 may comprise a C-type charge port or other type of charge port that is commonly associated with rechargeable electronic devices.

In use, the recipient user 14 touches the translate icon 56 displayed on the touch screen 46 to actuate the language translation program 54 when the recipient user 14 is in a situation that does not offer the recipient user 14 the privacy they would prefer when they might receive a phone call, such as during a medical appointment, for example. The language translation program 54 translates the incoming message into the coded audio such that the recipient user 14 can listen to the phone call without the fear of eavesdropping by other nearby individuals. Furthermore, the language translation program 54 can translate an incoming text message into the coded audio to enable the recipient user 14 to hear the incoming text message in a discrete manner. The language translation program 54 can be turned on or off at any time, according to the preferences of the recipient user 14, including being turned on or off in the middle of phone call.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mobile electronic code device for converting an incoming message into a coded audio signal to enhance privacy for a recipient user, said device comprising:
a personal electronic device being configured to be carried by the recipient user, said personal electronic device having a transceiver being in wireless communication with an extrinsic communication network, said transceiver receiving a communication signal from said extrinsic communication network wherein said transceiver is configured to receive an incoming message from a sender user that is intended for the recipient user;
a processor being integrated into said personal electronic device, said processor being in electrical communication with said transceiver;
an electronic memory being integrated into said personal electronic device, said electronic memory being in electrical communication with said processor, said electronic memory storing a database comprising a language translation program, said language translation program translating a message in said communication signal into a coded audio signal wherein said language translation program is configured to communicate the message to the recipient user in a code that only the recipient user can understand thereby enhancing privacy for the recipient user;
a speaker being integrated into said personal electronic device, said speaker being in electrical communication with said processor such that said speaker receives said coded audio signal from said language translation program wherein said speaker is configured to audibly emit the coded audio signal to the recipient user; and
a plurality of solar cells, each solar cell of said plurality of solar cells being coupled to said personal electronic device wherein each solar cell of said plurality of solar cells is configured to be exposed to sunlight for charging said personal electronic device.

2. The mobile electronic code device according to claim 1, wherein said personal electronic device includes:
a housing having a front wall and a back wall and an outer wall extending between said front wall and said back wall;
said outer wall has a bottom side and a first lateral side and a second lateral side;
said outer wall has a plurality of sound holes extending through said bottom side wherein said plurality of sound holes is configured to pass audible sounds through said bottom side;
said plurality of sound holes includes a plurality of first sound holes and a plurality of second sound holes;
said plurality of first sound holes is positioned between a center of said bottom side and said first lateral side; and
said plurality of second sound holes being positioned between said center of said bottom side and said second lateral side.

3. The mobile electronic code device according to claim 2, wherein:
said plurality of first sound holes is arranged in a plurality of first rows being evenly spaced apart from each other and being distributed between said front wall and said back wall;
said plurality of first rows is staggered with respect to each other thereby offsetting each first sound hole of said plurality of first sound holes in a respective first row of said plurality of first rows with respect to a respective first sound hole of said plurality of first sound holes in an adjacent first row of said plurality of first rows.

4. The mobile electronic code device according to claim 3, wherein:
said plurality of second sound holes is arranged in a plurality of second rows being evenly spaced apart from each other and being distributed between said front wall and said back wall; and
said plurality of second rows is staggered with respect to each other thereby offsetting each second sound hole of said plurality of second sound holes in a respective second row of said plurality of second rows with respect to a respective second sound hole of said plurality of second sound holes in an adjacent second row of said plurality of second rows.

5. The mobile electronic code device according to claim 1, wherein:
said housing has a front wall;
said mobile electronic code device includes a touch screen being integrated into said front wall of said housing;
said touch screen is sensitive to touch wherein said touch screen is configured to respond to being touched by the recipient user; and
said touch screen touch displaying indicia comprising a graphical user interface wherein said personal electronic device is configured to respond to operational commands from the recipient user when the recipient user touches said touch screen.

6. The mobile electronic code device according to claim 5, wherein said language translation program is turned on when a translate icon of said graphical user interface is selected wherein said touch screen is configured to turn said language translation program on and off based upon a decision of the recipient user to select said translate icon.

7. The mobile electronic code device according to claim 2, wherein:
said device includes a power supply being integrated into said housing;
said power supply being in electrical communication with said processor such that said plurality of solar cells charges said power supply; and
said power supply comprises:
a rechargeable battery being positioned within said housing, said rechargeable battery being in electrical communication with said processor; and
a charge port being recessed into said bottom side of said outer wall of said housing wherein said charge port is configured to be electrically mated to a charge cord, said charge port being in electrical communication with said rechargeable battery for charging said rechargeable battery, said charge port being located between said plurality of first sound holes and said plurality of second sound holes.

8. A mobile electronic code device for converting an incoming message into a coded audio signal to enhance privacy for a recipient user, said device comprising:
a personal electronic device being configured to be carried by the recipient user, said personal electronic having a transceiver being in wireless communication with an extrinsic communication network, said transceiver receiving a communication signal from said extrinsic communication network wherein said transceiver is configured to receive an incoming message from a sender user that is intended for the recipient user, said personal electronic device including:
a housing having a front wall and a back wall and an outer wall extending between said front wall and said back wall, said outer wall having a bottom side and a first lateral side and a second lateral side, said outer wall having a plurality of sound holes extending through said bottom side wherein said plurality of sound holes is configured to pass audible sounds through said bottom side, said plurality of sound holes including a plurality of first sound holes and a plurality of second sound holes, said plurality of first sound holes being positioned between a center of said bottom side and said first lateral side, said plurality of first sound holes being arranged in a plurality of first rows being evenly spaced apart from each other and being distributed between said front wall and said back wall, said plurality of first rows being staggered with respect to each other thereby offsetting each first sound hole of said plurality of first sound holes in a respective first row of said plurality of first rows with respect to a respective first sound hole of said plurality of first sound holes in an adjacent first row of said plurality of first rows, said plurality of second sound holes being positioned between said center of said bottom side and said second lateral side, said plurality of second sound holes being arranged in a plurality of second rows being evenly spaced apart from each other and being distributed between said front wall and said back wall, said plurality of second rows being staggered with respect to each other thereby offsetting each second sound hole of said plurality of second sound holes in a respective second row of said plurality of second rows with respect to a respective second sound hole of said plurality of second sound holes in an adjacent second row of said plurality of second rows; and
a touch screen being integrated into said front wall of said housing, said touch screen being sensitive to touch wherein said touch screen is configured to respond to being touched by the recipient user, said touch screen touch displaying indicia comprising a graphical user interface wherein said personal electronic device is configured to respond to operational commands from the recipient user when the recipient user touches said touch screen;
a processor being integrated into said personal electronic device, said processor being in electrical communication with said transceiver, said processor being in electrical communication with said touch screen;
an electronic memory being integrated into said personal electronic device, said electronic memory being in electrical communication with said processor, said electronic memory storing a database comprising a language translation program, said language translation program translating a message in said communication signal into a coded audio signal wherein said language translation program is configured to communicate the message to the recipient user in a code that only the recipient user can understand thereby enhancing privacy for the recipient user, said language translation program being turned on when a translate icon of said graphical user interface is selected wherein said touch screen is configured to turn said language translation program on and off based upon a decision of the recipient user to select said translate icon;
a speaker being integrated into said personal electronic device, said speaker being aligned with said plurality of sound holes wherein said speaker is configured to emit audible sounds outwardly through said plurality of sound holes, said speaker being in electrical communication with said processor such that said speaker receives said coded audio signal from said language translation program wherein said speaker is configured to audibly emit the coded audio signal to the recipient user through said plurality of sound holes;
a plurality of solar cells, each solar cell of said plurality of solar cells being coupled to said personal electronic device wherein each solar cell of said plurality of solar cells is configured to be exposed to sunlight for charging said personal electronic device, each solar cell of said plurality of solar cells being positioned on said back wall of said housing, said plurality of solar cells being in electrical communication with said processor; and
a power supply being integrated into said housing, said power supply being in electrical communication with said processor such that said plurality of solar cells charges said power supply, said power supply comprising:
a rechargeable battery being positioned within said housing, said rechargeable battery being in electrical communication with said processor; and
a charge port being recessed into said bottom side of said outer wall of said housing wherein said charge port is configured to be electrically mated to a charge cord, said charge port being in electrical communication with said rechargeable battery for charging said rechargeable battery, said charge port being located between said plurality of first sound holes and said plurality of second sound holes.
